(19) United States
(12) Patent Application Publication
(10) Pub. No.: US 2011/0289021 A1
(43) Pub. Date: Nov. 24, 2011

(54) METHOD FOR UTILIZING INTELLECTUAL PROPERTY AS COLLATERAL TO FACILITATE LOANS TO SMALL BUSINESSES TO CREATE JOBS AND STIMULATE THE ECONOMY

(76) Inventor: Robert W. Fletcher, Louisville, KY (US)

(21) Appl. No.: 12/877,576

(22) Filed: Sep. 8, 2010

Related U.S. Application Data
(63) Continuation-in-part of application No. 12/800,587, filed on May 19, 2010.

(51) Int. Cl. G06Q 90/00

(52) U.S. Cl. 705/500

(57) ABSTRACT

The present invention is a method of facilitating the use of intellectual property as a financial tool in commercial, non-profit or eleemosynary transactions in the context of venture capital and commercial banking for-profit transactions comprising:
a) identifying one or more items of intellectual property;
b) identifying the owners of the intellectual property and any other principals in interest having rights and/or interests directly or indirectly in said intellectual property, which owners, or principals in interest have an interest in entering into commercial transactions involving said intellectual property;
c) valuing the intellectual property, identifying its strengths and weaknesses both commercially and legally;
d) underwriting the intellectual property for purposes of issuing one or more policies of insurance covering one or more of the identified commercial or legal strengths or weaknesses and,
e) structuring such transactions.

### I. RELATED PATENT

This patent application is a continuation in part of U.S. patent application Ser. No. 12/800,587, filed May 19, 2010, and entitled: Method of Determining Orderly Liquidation Value of Patents. Also U.S. Pat. No. 7,536,331 entitled: Method for Determining the Risk Associated with Licensing or Enforcing Intellectual property, issued May 19, 2009, is of interest. Both U.S. application Ser. No. 12/800,587 and U.S. Pat. No. 7,536,331 are hereby incorporated by reference.

### II. BACKGROUND OF THE INVENTION

As the universal body of knowledge grows, intellectual property becomes more and more of an important part of a company's value which increasingly extends throughout the global economy. Intellectual property in the form of patents, copyrights, trademarks, trade dress, trade secrets and associated know-how, is an intangible asset, and it represents a growing source of income among individuals and entities. Patents in particular have a significant role in contributing to increased revenue streams because of their use as legal leverage to define and establish an exclusive market for their owners, opening the way for higher profits through a time-limited monopoly. Generally, unless the intellectual property is purchased for a sum certain amount, accountants do not include the intellectual property in the valuation of an individual or entity.

‘Patents do however serve another useful purpose if viewed in a slightly different light. While patents do serve the legal purpose described above, they also serve the purpose of making an intangible asset more tangible. A patent can be viewed as a document which defines a valuable process, machine, article of manufacture or composition of matter. It describes the process, machine, manufacture or composition of matter in such clear, concise and exact terms that it enables one skilled in the art to make or practice the same. Moreover the patent represents value because the invention described has been found to meet minimum standards because it has been passed upon by a board of review (the patent office) and found to meet the statutory standards. Therefore when handling a patent it takes on the identity of the invention it protects and gives an aura of tangibility to an otherwise intangible property.

Historically, corporate assets were inventory, raw and in-process, as well as receivables and “bricks and mortar”. However, with the change in world dynamics and in light of the greater role of third world countries in manufacturing, the character of corporate assets is changing. One reason for the change is the desire of corporations to maintain smaller levels of inventory and no or smaller, more efficient manufacturing plants. A comparison of the market values and the book values of the Fortune 500 companies reveal that the market values far exceed the value that accountants can find using traditional GAAP methods. The question can be raised, where does that value come from? The answer is, from the intellectual assets of the companies—their intellectual property. It is these assets that companies now wish to use in traditional roles.

As a general rule, when intellectual property is included in financial statements, it is aggregated and categorized under the heading of goodwill. However in more recent times the item of goodwill is recorded as only a small fraction of is the difference between the total asset value as recorded on the balance sheet and the market value determined by multiplying the number of outstanding shares times the price per share of the entity as a whole. This sometimes very large difference is not recorded on the balance sheet; thus, financial statements of an entity's worth frequently do not account for items of intellectual property as having independent value. Such accounting practices result in the potential for gross undervaluation of a portfolio of intellectual property, and thus the value of the holding entity, and consequently the larger economy as a whole.

Fortuitously, the aforementioned U.S. patent application Ser. No. 12/800,587 has provided the needed solution to the perplexing patent valuation problem, thus opening the door for the use of patents as financial tools to represent and allow their use as the assets they truly are. The next step in achieving the goal of using patents as assets is to develop a method for using patents as collateral for a loan. The present invention solves the problem of combining the fundamentals of entities and financial arrangements thus enabling the use of patents as collateral for a loan. The patent itself with its aura of tangibility of the underlying invention makes the concept of collateral all the more real.

### III. SUMMARY OF THE INVENTION

The method of the present invention is a method of facilitating the use of intellectual property as a financial tool in commercial, non-profit or eleemosynary transactions in the context of venture capital and commercial banking for-profit transactions comprising:

identifying one or more items of intellectual property; identifying the owners of the intellectual property and any other principals in interest having rights directly or indirectly in said intellectual property, which owners, or principals in interest have an interest in entering into commercial transactions involving said intellectual property; valuing the intellectual property, identifying its strengths and weaknesses both commercially and legally; and underwriting the intellectual property for purposes of issuing one or more policies of insurance covering one or more of the identified commercial or legal strengths or weaknesses.

The present invention comprises a method of facilitating the use of intellectual property as a financial tool in general commercial, non-profit, eleemosynary, venture capital, or commercial banking transactions, comprising identifying one or more items of intellectual property, identifying the owner or owners of the intellectual property and any other actual or potential principals in interest having or wishing to have rights directly or indirectly in said intellectual property, which owners, or actual or potential principals in interest have an interest in entering into commercial transactions involving said intellectual property, valuing the intellectual property, identifying its strengths and weaknesses both commercially and legally, and underwriting the intellectual property for purposes of issuing one or more insurance policies covering one or more of the identified commercial or legal strengths or weaknesses.

Further, the present invention comprises a method wherein the item of intellectual property is a patent, copyright, or trademark.

Further, the present invention comprises a method wherein a lending institution lends money to said owner or owners of intellectual property in exchange for a security interest in collateral, the collateral being said intellectual property.

Further, the present invention comprises a method wherein said lending institution is aware of said one or more insurance policies, and the existence of said one or more policies of insurance is a factor in the decision to lend, or in the terms of the loan.

Further, the present invention comprises a method wherein said lending institution takes a security interest in said collateral, and said one or more insurance policies is issued to said lending institution, insuring said collateral against loss up to a specified monetary limit. Further, the present invention comprises a method wherein said specified monetary limit approximates the potential sale proceeds from said collateral in the event of a quick sale.

Further, the present invention comprises a method of financing an entity's activities, comprising identifying one or more intangible assets, identifying the owner or owners of said one or more intangible assets and any other actual or potential principals in interest having or wishing to have rights directly or indirectly in said one or more intangible assets, which owner or owners or actual or potential principals in interest have an interest in entering into commercial transactions involving said one or more intangible assets, or in adopting or justifying a specific monetary value of said one or more intangible assets for accounting purposes, underwriting said one or more intangible assets by identifying and weighing commercial and legal risk of partial or complete loss of the intangible asset, which underwriting results in output in the form of an insurance quotation or report specifying a monetary limit of funds which are available contingent upon loss of the intangible asset, to insure the commercial or legal risk of loss of the intangible asset, assigning a monetary value to the intangible asset based upon said output, selling or leveraging said intangible asset, based upon the assigned monetary value of the intangible asset, and engaging in financing activity enabled by the leverage or sale of said intangible asset.

Further, the present invention comprises a method wherein at least one of said one or more intangible assets is a patent, copyright, trademark, good will, proprietary list, database, or trade secret.

Further, the present invention comprises a method wherein a lending institution lends to said owner or owners of said one or more intangible assets in exchange for a security interest in collateral, the collateral being one or more of said intangible assets.

Further, the present invention comprises a method wherein the lending institution is aware of said insurance quotation or report, and the existence of said insurance quotation or report is a factor in the lending decision or in the terms of the loan.

Further, the present invention comprises a method of wherein the lending institution takes a security interest in said collateral, and said insurance quotation or report is issued to said lending institution, insuring said collateral against loss up to a specified monetary limit of funds.

Further, the present invention comprises a method wherein said specified monetary limit approximates the potential sale proceeds of said collateral in the event of a quick sale.

Further, the present invention comprises a process of engaging in financial activity involving leverage or sale of an intangible asset, comprising the steps of gathering input data from one or more information sources regarding an intangible asset, evaluating said input by identifying and weighing commercial and legal risk of partial or complete loss of said intangible asset, creating output in the form of a report or an insurance quotation or report regarding said intangible asset naming a value which is the maximum limit of investment or collateral value to be used to insure the commercial or legal risk of loss of the intangible asset, assigning a monetary value to the intangible asset based at least in part upon said output, selling or leveraging said intangible asset, based upon the assigned monetary value of the intangible asset, and engaging in financing activity enabled by the leverage or sale of said intangible asset.

Further, the present invention comprises a process wherein at least one of said one or more intangible assets is a patent, copyright, trademark, good will, proprietary list, database, or trade secret.

Further, the present invention comprises a process wherein said financing activity enabled by the leverage or sale of said intangible asset is a loan.

Further, the present invention comprises a process wherein said financing activity enabled by the leverage or sale of said intangible asset is a loan, and said loan is requires said intangible asset as collateral.

Further, the present invention comprises a method of identifying one or more intangible assets, identifying the owners of said intangible asset and any other actual or potential principals in interest having or wishing to have rights directly or indirectly in said intangible assets, which owners or actual or potential principals in interest have an interest in entering into commercial transactions involving said intangible assets, or for adopting or justifying a specific monetary value of said intangible assets for accounting purposes, underwriting said intangible asset by identifying and weighing commercial and legal risk of partial or complete loss of the intangible asset, which underwriting results in output in the form of an insurance quotation or report naming a specific monetary limit of funds which are available for purchase to insure the commercial or legal risk of loss of the intangible asset, and assigning a monetary value to the intangible asset based upon said output.

Further, the present invention comprises a method wherein at least one of said one or more intangible assets is a patent, copyright, trademark, good will, proprietary list, database, or trade secret.

Further, the present invention comprises a specific monetary value assigned to an intangible asset, comprising underwriting said intangible asset by identifying and weighing commercial and legal risk of partial or complete loss of the intangible asset, which underwriting results in output in the form of an insurance quotation or report naming a specific monetary limit of funds which are available for purchase to insure the commercial or legal risk of loss of the intangible asset, and assigning a monetary value to the intangible asset based upon said output.

Further, the present invention comprises the specific monetary value wherein said intangible asset is a patent, copyright, trademark, good will, proprietary list, database, or trade secret.

Further, the present invention comprises an insurance product comprising: an insurance policy issued to a holder in exchange for premium, which compensates said holder in the event of loss of one or more items of intangible collateral, where said holder has loaned money to an entity and taken a right in one or more intangibles as collateral for the loan.

Further, the present invention comprises an insurance product comprising: an insurance policy issued to a third party in exchange for payment of premium which compensates said third party or its creditor in the event of loss of one or more items of intangible property, where an insurer obtains rights in one or more items of intangible property owned by a third party, and in exchange for the premium and rights guarantees said third party's lender in the event of third party's default on a loan lender has made to said third party, thereby causing the loan to become more attractive to said lender.

The method of the present invention can be facilitated by utilizing several entities and agreements which provide a financial structure through which parties with an interest in an item of intellectual property can insure the intellectual property's minimum financial performance. Of the entities involved in achieving the objective of this invention one category is lending institutions wishing to have assurance of the intellectual property's minimum value when the intellectual property is used as collateral for a loan.

The method of the present invention enables an intellectual property owner to use the intellectual property as collateral for a loan. One agreement or document used in the practice of this invention has the characteristics and provisions similar to an insurance policy and is executed between a source of money and a guarantor. It protects against the legal risk of the intellectual property being invalidated and protects against other commercial risks potentially diminishing or destroying the intellectual property's value such as the technical, commercial or regulatory changes. Of most concern is that the underlying patented technology would somehow become valueless primarily through technical obsolescence or regulatory intervention.

The guaranteeing document hereafter referred to intellectual property insurance policy (or policy) reimburses the lender, as distinguished from intellectual property owner, for the outstanding loan balance under circumstances where the lender has loaned against intellectual property as collateral, and a foreclosure sale results in a shortfall. This intellectual property insurance policy permits companies to borrow money against their intellectual property as opposed to being forced to go to the venture capital market for financing. A loan at this stage of a company's development is particularly attractive since early venture capital financing usually requires the divestiture of a very significant ownership position which later could be sold for a much greater amount of money. This new intellectual property insurance policy permits intellectual property owners to work with insurance companies and financial institutions to truly use their intellectual property assets as financial tools.

The policy is marketed to third parties who have a financial interest in the Intellectual Property. For example, a bank may require the purchase of such a policy in its name because of a loan made based upon the licensing royalties of a patent or based upon a valuation of the patent itself. Other markets include inventors of intellectual property that may be able to use an insured patent as a booked asset or wish to use their intellectual property as loan collateral to further develop their inventions.

### IV. DESCRIPTION OF THE DRAWINGS

FIG. 1 is the basic structure of the entities of the present invention.

FIG. 2 is a diagram of the agreements required to facilitate the practice of the preferred embodiment of the invention.

FIG. 3 is an underwriting/valuation timeline.

FIG. 4 is the time line illustrating the sequence of events from pre-application to policy payment.

### V. DESCRIPTION OF THE PREFERRED EMBODIMENT

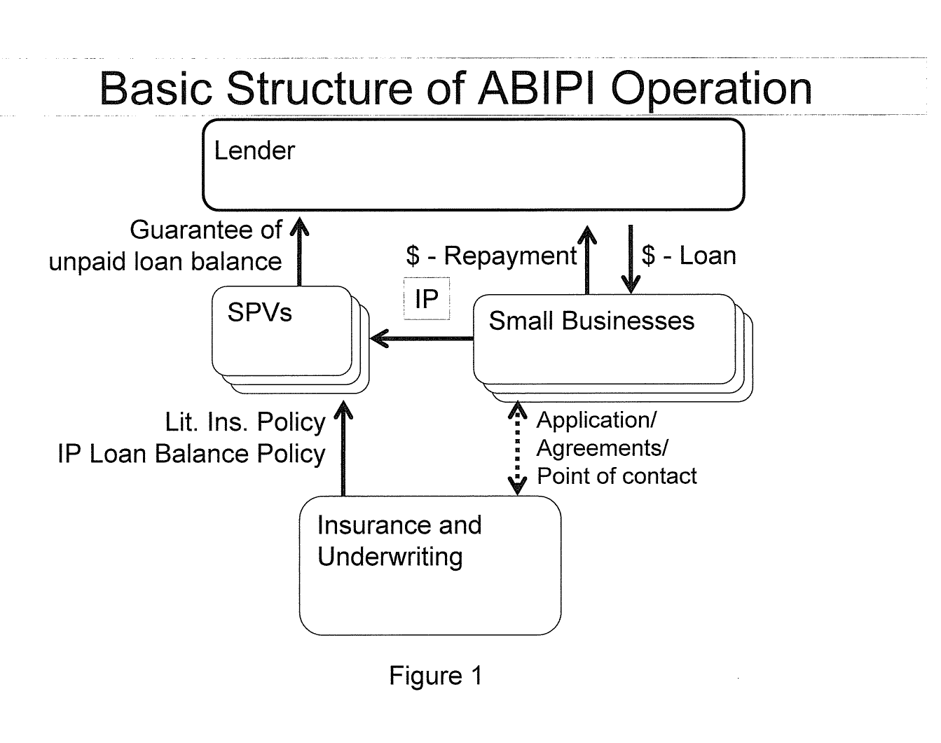

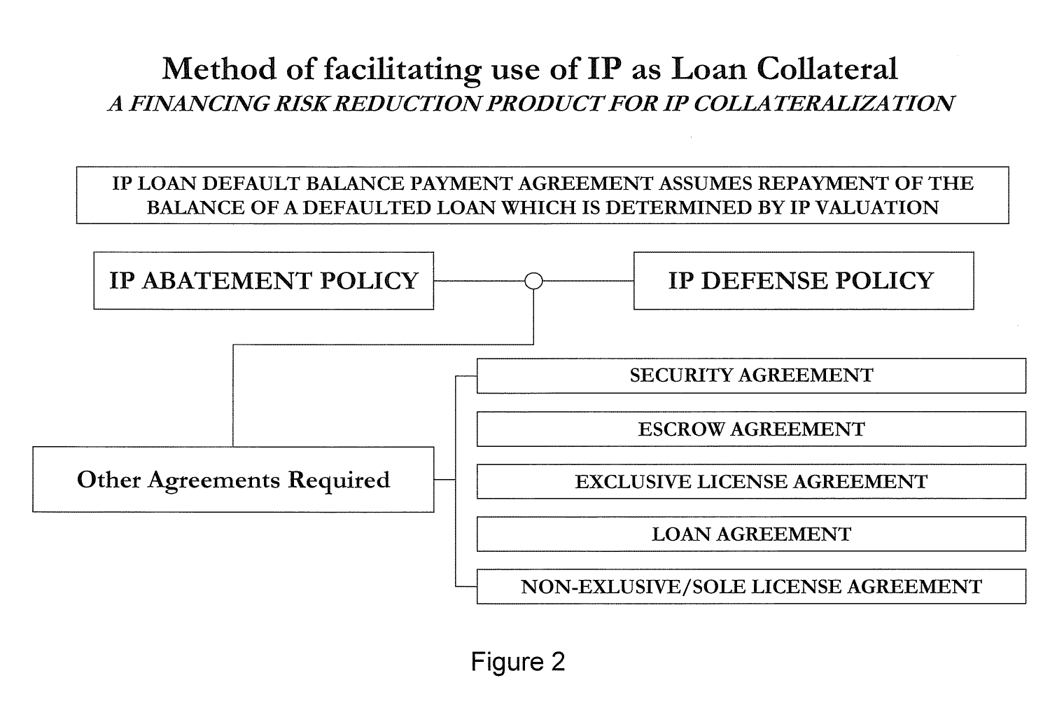

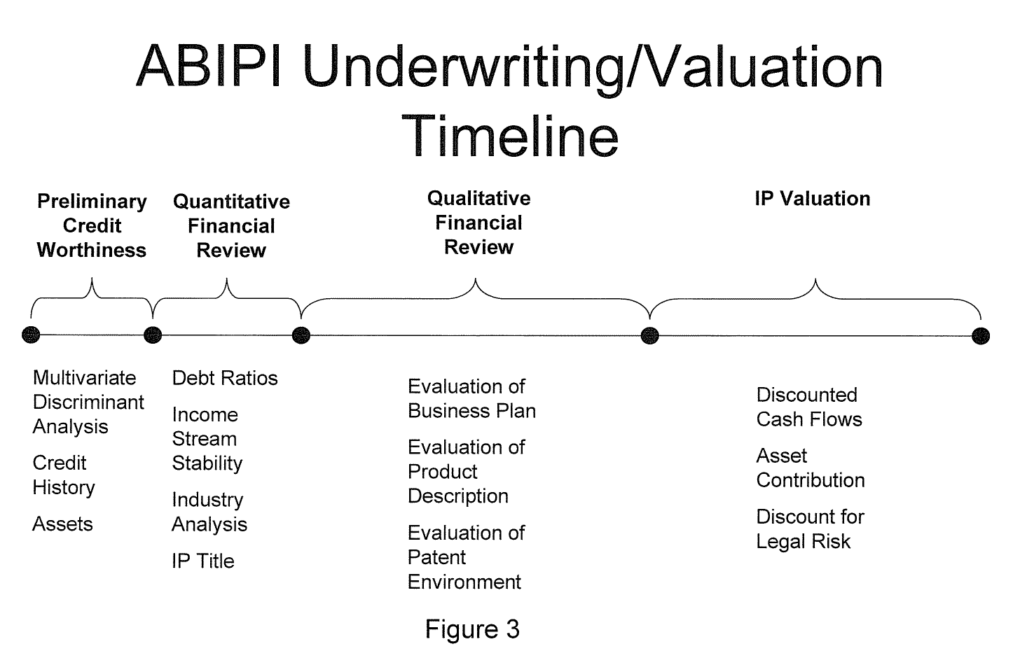

FIG. 1 shows a lender which is the source of loan money to one or more small businesses. FIG. 2 shows the agreements involved. The loan agreement provides for the borrowing of money, the amount of which is determined by the underwriting method of FIG. 3. The underwriting method is described more fully in U.S. patent application Ser. No. 12/800,587; filed May 19, 2010 entitled Method of Determining Orderly Liquidation Value of Patents. It is this orderly liquidation value which sets the maximum amount of money which the patent or patents could reasonably collateralize in support of a loan. Typically, lenders may choose to loan an amount which is a fraction of the orderly liquidation value. Such amounts can range from 10% to 80% of the orderly liquidation value preferably based upon the views of the lender.

In addition to conventional loan terms including the repayment either as a balloon payment or amortization over a period of time the loan document will contain other specific provisions relating to and enabling the method of the present invention. The first of such terms is provision for an escrow agreement which will serve to permit the lender to direct part of the loan proceeds to an escrow account, which proceeds will then be available to service the money requirements for payment of Intellectual Property Defense and Enforcement Policy premiums. The escrow account will also contain funds for additional interest payments if there is a default on the loan agreement, which interest payments preferably are to run for a period of 150 days past the first payment default.

The loan agreement will further provide that the borrower must report any facts, events, activities or circumstances relating to the intellectual property collateral to the lender. The reporting requirement includes but is not limited to any civil proceeding as defined in the abatement and defense insurance policies referred to above which may relate to or cause a possible loan default. The Borrower must thereafter cooperate with the lender and the insurance company by keeping both fully informed of any subsequent developments.

The loan agreement shall further provide that the borrower agrees that the company issuing the abatement and defense and other agreements or policies has the right but not the duty at any time to assume the legal representation of the borrower in respect to any civil proceeding having the potential to result in an intellectual property loan default and thereafter, the borrower shall be required to provide the company with full cooperation and such information as the company may reasonably require.

Further the loan agreement shall provide that even if the company or the lender does not assume the defense of the borrower the company shall nevertheless, have the right to effectively associate with the borrower in the defense and settlement of any such civil proceeding including but not limited to exercising the right to approve counsel, have its own counsel made of record in any civil proceeding and effectively and meaningfully associate in the negotiation of any settlements.

Also, consistent with the conditions referenced above, the loan agreement shall require that the borrower not admit any liability for or settle any matter involving any Civil Proceeding having the potential to result in an intellectual property Loan Default or stipulate to any judgment without the company's prior written consent which consent shall not be unreasonably withheld.

Consistent with the foregoing, the loan agreement shall also provide that if any of all parties in interest refuses or fails within 30 days of mailing or delivering by Company to any of all parties in interest a written recommendation from the Company, to consent to any settlement within the policy limits recommended by the Company and acceptable to the opponent in a Civil Proceeding, then:
1. The Company may withdraw from the representation of any of all parties in interest by tendering control of the representation to that or those all parties in interest, who shall thereafter, at its/their own expense, pursue, negotiate or defend such Civil Proceeding independently of the Company; and
2. The Company's liability shall first be reduced by the Litigation Expenses if any incurred by the Company and then shall not exceed the smaller of (i) the then remaining applicable policy limit, or (ii) the amount of Non-Compensated Loss portion of the loss of Intellectual Property Loan Value which had accrued to the point in time where the recommendation could have been consented to.

Commensurate with execution of the loan agreements and its special provisions the borrower/small-business enters into an agreement conveying interest in the intellectual property to a special purpose vehicle (SPV) which is a bankruptcy remote company set up specifically to receive the intellectual property being pledged as collateral. The conveyance of the intellectual property is preferably either by assignment or by exclusive license. The exclusive license may be most preferred but any contract is suitable provided it effects a transfer of the intellectual property to the special purpose vehicle in a way which renders that pledged intellectual property remote from any bankruptcy proceeding to which the borrower may later be a party. The SPV, upon receipt of the pledged intellectual property will typically issue a non-exclusive license back to the pledging/borrower/small business. The non-exclusive license agreement may be a sole license agreement providing that only the licensee is permitted to practice the subject matter defined by the intellectual property while the loan is in good standing. This sole license agreement will typically contain a provision which states that upon a loan default the license is terminated. In conjunction with the termination of the sole license the exclusive license will automatically become an assignment thus leaving the SPV in a position to begin the search for a purchaser of the intellectual property collateral.

At the time of the exclusive license agreement there is also executed a security agreement. The security agreement establishes the SPV's right to the intellectual property pledged as collateral in the event of a loan default. This security agreement is filed with the appropriate authorities to perfect a lien against the collateralized intellectual property. Thus, in the preferred embodiment the method of facilitating use of IP as loan collateral consists of the IP loan default balance payment agreement (i.e. an Asset Backed Intellectual Property Insurance Policy), an IP abatement insurance policy, an IP defense insurance policy, a security agreement, an escrow agreement, an exclusive license agreement, a loan agreement and a non-exclusive/sole license agreement all as shown in FIG. 2. These agreements should preferably be issued concurrently with each other and read in conjunction with each other.

Referring now to FIG. 3, it can be seen that the entire underwriting scenario for determining whether or not a loan should be extended to the loan applicant involves more than the valuation of the IP proposed as collateral. In the preferred embodiment there are three precursor steps. The first is a preliminary creditworthiness determination. This preliminary creditworthiness can preferably be initiated by utilizing a variation of the Altman Creditworthiness Formulations reviewed and presented by Nobel Prize winner, J. R. Altman. The preliminary creditworthiness determination is preferably a multi-variant discriminate analysis taking into consideration the credit history, assets, longevity and the like of the loan applicant.

Next, a quantitative financial review is undertaken examining various financial ratios as are known arid applied typically by lenders, accountants and financial advisors. Also an income stream stability analysis should be undertaken. A general industry analysis identifying industry trends and overall growth should be undertaken. Importantly, the title to the proposed, pledged intellectual property should be thoroughly investigated to ascertain that title resides in the applicant/borrower seeking the loan.

Similarly, a qualitative financial review of the borrower should be undertaken. This qualitative financial review should include an evaluation of the business plan, evaluation of the product, its description, its history, life and any applicable governmental regulations or prohibitions which could apply thereto. An evaluation of the patent environment is conducted with a view both toward establishing the strength and viability of the patents or other IP to be pledged as well as the holdings of competitors in the field. The evaluation of the patent environment may be conducted in large portion during the underwriting of applications for required abatement and defense intellectual property insurance. The underwriting of the abatement and defense policies is done in accordance with the method claimed in U.S. Pat. No. 7,536,331 referenced above. Lastly, the IP valuation step itself is performed in accordance with U.S. patent application Ser. No. 12/800,587; filed May 19, 2010 entitled Method of Determining Orderly Liquidation Value of Patents.

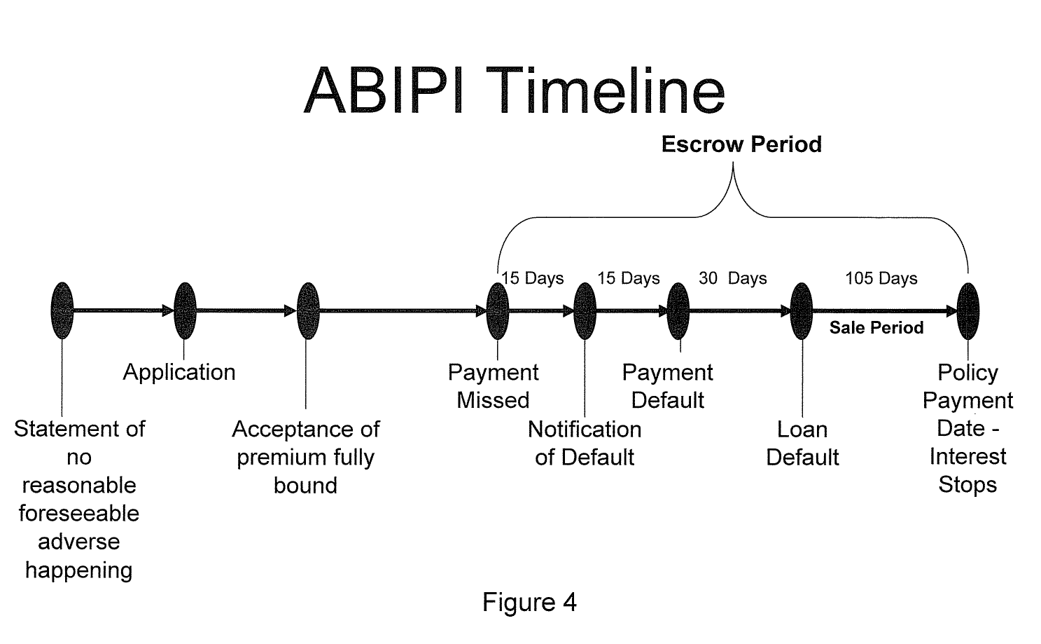

The entire time line beginning with a borrower wishing to borrow money and a willing lender willing to lend money provided that the loan is collateralized by intellectual property through an IP loan default balance payment agreement, referred to as an IP Loan Default Balance Insurance Policy otherwise referred to as an Asset-Backed Intellectual Property Insurance Policy, through the vehicle of a bankruptcy remote company also known as a Special Purpose Vehicle (SPV) effected through various agreements is shown in FIG. 4. Even before a loan application is received, it is preferable there be a statement of “no reasonable, foreseeable adverse happening” which essentially is a statement indicating that the activities which the loan is intended to finance would not be subject to claims of 3^{rd} parties.

The next step is the submitting of an application for the loan and concurrently the application for an IP loan default balance payment policy. The application documents will necessarily include a business plan, a product description, and an evaluation of the patent environment as well as sufficient financial information to enable calculations of various debt ratios as determined to be made by the lender. Upon the parties being identified and/or formed as the case may be with any required SPV of FIG. 1 the underwriting of the transaction begins according to the steps outlined in FIG. 3 and concurrently the underwriting, defined as determining the risk as taught in U.S. Pat. No. 7,536,331, begins.

After the application process has been finished and found acceptable a quote is issued and preferably the documents of FIG. 2 are prepared and executed between the parties of FIG. 1 as described above. As the loan proceeds are being used typically amortization or preferably interest only payments are being made.

In the event a payment is missed the lender must supply to the SPV and the guarantor/the insurance company a notification of default. If payment is not received within the next fifteen days a payment default has occurred and in addition a second payment may be due. In any event if at least one payment is not received within the next 30 days the loan is considered to be in default (A Loan Default has occurred) and the exclusive license converts to an assignment in favor of the lender. The non-exclusive or sole license agreement is determined to be breached and therefore, terminated and the sale period begins. The SPV becomes active in attempting to sell the IP collateral with notification to the lender/insurer of the actions it has taken with respect thereto. The activities beginning with the first payment being missed, through the end of the sale period is the escrow period. The escrow period as shown in FIG. 4, begins with the first missed payment and includes the notification default, the payment default, the loan default and finally the policy payment date. During this period escrowed monies are used to pay the accrued interest to the lender.

At the end of the escrow period foreclosure is effected with the proceeds of the sale of the IP collateral being applied to the outstanding loan balance, provided the insurer has not previously indicated that it will take possession of the collateral IP in lieu of a sale of the IP. In the alternative, in the present preferred embodiment, if there was no sale of the IP, then the policy reimburses the outstanding loan amount. Interest does not accrue thereafter. If an investor in the applicant insured or other interested party has offered to pay the outstanding loan balance, the lender/insurance company must accept the payment and relinquish claim to the IP provided the purchase by the interested third party completely relieves the insurance company's obligation and the lender is fully compensated to the extent required by the policy. It is however, in the preferred embodiment expected that the insured borrower will still remain liable to the insurance company for the outstanding balance of the loan under the insurance rights of subrogation.

The asset backed intellectual property insurance policy term is coextensive with the term of the loan, usually three (3) years. The loans are typically structured with interest payments throughout the term and with the principal due upon expiration of the term. The loans are full recourse loans.

Coverage under the asset backed intellectual property insurance policy extends to defaults not cured within a predetermined time frame. As a requirement for the loan and as a requirement for eligibility for insurance, a Loan Monitoring Agent/Asset Manager may be in place for purposes of ensuring that the intellectual property owner is adhering to an approved commercialization plan; and, if not, to put in place licensing/sale procedures to payoff the loan/default.

Safeguards are in place to not only monitor the commercialization but to also escrow up to twenty percent (20%) of the loan proceeds to fund losses on interest defaults, if necessary.

Included in the escrow will be proceeds to cover payments for:
Infringement Abatement Insurance (at required limits set by the Insurance Carrier, Lender and/or the Underwriting entity)
Defense Infringement Insurance (at required limits set by the Insurance Carrier, Lender and/or the Underwriting entity)
Loan monitoring and asset management fees
One-half of the Asset Backed Intellectual property Insurance Premium (which could be as high as twelve percent (12%) or more of loan value) with a larger percentage paid upfront and the balance of payments spaced over the policy period.

In commercial banking transactions occasionally the loss of intellectual property value will be determined via a “loss of royalty analysis” that calculates the royalty stream that would have been paid in the event the patent had not been invalidated. The market will dictate what limits are going to be offered, keyed to the lenders' needs to insure the loan. Loss is measured by uncompensated loss after sale of the patent. Precautions are taken during the underwriting process to avoid the moral hazard of providing intellectual property value policies in excess of the intellectual property's real market value.

There are six (6) factors which unite to make asset backed intellectual property insurance workable. Four (4) of the factors are quite apparent from the available information but the other two (2) are only apparent to those observant in the world of patents. The apparent factors are as follows:
The patents that are collateral will have a value far in excess of the amount they can be sold for—by deliberate selection.
The premiums can be high enough to make the insurance profitable because the only competition is the venture capital market which measures cost in terms of stock ownership.
The risk of adverse litigation can be obviated by the mandatory purchase of Abatement and Defense Insurance.
The amount paid out in the form of claims will actually be booked as an asset not a loss. This is because GAAP requires that an item (the intellectual property) received in exchange for paying off a loan must be booked at either its market value or the amount paid out in satisfaction of that loan. So, in the worst case the amount booked would be the amount paid as a claim. In the best case scenario the amount booked would be many times the amount paid as a claim.

The two factors that are not readily apparent are:
An inventor treats his intellectual property as protectively as he treats his children because his inventions are his claim to immortality. Thus, one of the last loans he will let go into default is the one that would cause him to lose his patents.
The proceeds of the loan are being used to make the collateral more valuable because the invention is being perfected and commercialized.

The following characteristics of the borrower are required and common to all asset backed intellectual property insurance business structures.
1. The borrower must own the intellectual property or the intellectual property owner must be willing and agree in writing that the intellectual property may be used as collateral for the purposes of loaning funds to the borrower.
2. The intellectual property being considered for use as collateral must be free and clear from any liens, assignment issues, encumbrances, loan obligations, etc.
3. The intellectual property being considered for use as collateral must not be involved in any re-examinations, re-issues, declaratory judgments, oppositions, International Trade Commission (ITC) actions or any intellectual property related civil proceedings.
4. The borrower must have a reasonable debt structure and debt payment history.
5. The borrower must be able to show proof of an income stream or high probability of an income stream that can service the impending debt.

Each of these required characteristics will be reviewed during underwriting due diligence. The underwriter's findings will be recorded in the underwriting manual. Additionally, a number of written, warranted statements will be required from the borrower to assure that the above stated facts and representations are true. The written agreements and statements required are as follows.
1. Asset backed intellectual property insurance application.
2. Affidavit by intellectual property owner stating that said owner owns the intellectual property, understands said intellectual property is being used as collateral to secure a loan and understands the failure to repay the loan will result in loss of ownership of the intellectual property being used for collateral.
3. Affidavit by intellectual property owner stating that he or she owns the intellectual property free and clear and no issues of ownership have occurred and the intellectual property being pledged as collateral will remain unencumbered for the duration of the loan.
4. Affidavit by intellectual property owner and/or legal representative stating the intellectual property being considered for use as collateral is not currently or expected to be involved in any re-examinations, re-issues, declaratory judgments, oppositions, International Trade Commission (ITC) actions or any intellectual property related civil proceedings.
5. Submission of all licensees and all licensee agreements.
6. Business plan.
7. Annual financial report for the last two years.

As a condition to the asset backed intellectual property insurance being issued, concurrent accompanying intellectual property Defense and Abatement policies are required. Both enforcement (abatement) of the applicant's intellectual property and defense against others alleging infringement of the products envisioned in the valuation of the intellectual property is provided by these policies.

The technical/commercial risk protected by this policy is the possibility that the borrower will default on the loan granted by the Named Insured, will go out of business, and thus, leave the Named Insured with collateralized intellectual property which may or may not have a continuing value. The policy will reimburse the Named Insured for the Non-compensated Loss it has suffered in the course of having made a loan or otherwise paid or advanced money to the borrower. Within the definition of the borrower are any other persons or entities benefiting from the payments promised or made to assure the payment of monies based upon the actual or perceived value of the income potential of intellectual property, actual and future income of intellectual property, the established purchase price of intellectual property in a commercial sale thereof and like transactions. Within the definition of the lender are the lender and any person(s) working on the lender's behalf The asset backed intellectual property insurance policy does not protect against misdeeds, such as, but not limited to, misrepresentations and false information or fraud, or the discretionary decisions unrelated to the fact that the collateral is intellectual property. Nor does it protect against Directors and Officers misfeasance, malfeasance or fraud; advertising injury; work stoppages/losses resulting from movement of stock prices; losses from interest rate changes and/or breach of contract.

The borrower can select the intellectual property within the Borrower's intellectual property portfolio with no requirement that the entire Portfolio be used. However, if the patents are determined to be subservient to another patent within the portfolio, then the dominant patent will always be required to be used as collateral.
If a Borrower defaults on its obligations under a Loan, the Named Insured will be reimbursed for Non-Compensated Loss, defined as the unpaid loan balance plus unpaid interest, less any Offsetting Compensation derived from commercial activity of the company or Recovered Costs, including any monies received via litigation. Non compensated loss means the unpaid loan obligations (including, without limitation, the unpaid loan balance, plus interest, plus collection expenses) less recovered costs and offsetting compensation. Non-compensated loss arising out of the same act or a duplication of an act or out of a series of interrelated acts shall be considered as giving rise to a single claim reimbursed by a single policy irrespective of the number of intellectual property defaults, civil proceedings, demands on the Company for reimbursement, Plaintiffs, Defendants, or the number of covered intellectual property(ies) or the years or policies under which the claim(s) is made.

An example of offsetting compensation is the sale of products and/or royalties recovered after default during run-off. An example of recovered costs is monies that are recovered from litigation and fines, awards and penalties collected from an adversary.

In the preferred embodiment it is a requirement that to be entitled to make a claim the Named Insured must, at the time coverage under the policy is sought, make a statement of No Reasonably Foreseeable Adverse Happening

### Example 1

After having conducted extensive patent searches and opinions and closely monitoring intellectual property in the art area, a small inventor, who was not identified as a risk, emerges with a law suit against the insured. This is not a reasonably foreseeable adverse happening.

### Example 2

After maintaining stable royalties from licensee X for a number of years, Licensee X suddenly and without warning goes out of business and a significant portion of the borrower's cash flow disappears. The borrower can no longer pay his/her payments on the asset backed intellectual property insurance loan. This is not a reasonably foreseeable adverse happening.

Moreover, to make a claim the Named Insured must provide Notice of Default within 45 days of first knowledge of default and submit a Claim Form a certified statement of the amount of Non-Compensated Loss, when the possibility of loss was first discovered, and reasonable proof acceptable to the Insurer that such loss has occurred

Examples of reasonable proof acceptable to the Insurer are:
A. The audited books of account of the Named Insured showing all accounts and transactions with respect to the borrower. The standard of proof is the same as if one were proving a debt in a legal sense.
B. The failure of the Borrower to provide evidence of payment of the loan obligations.

After the Named Insured has submitted a claim, the Insurer will, as soon as practicable, acknowledge consideration of the Claim and, if approved, make reimbursement within 30 days. How soon is practicable?
A. Practicable is situational. The time period involved is dependent on obtaining all pertinent information to the Claim.

The Named Insured is responsible to disclose all information that the Named Insured has reasonable access to. Additionally, the Named Insured is responsible for duty of due diligence, such as verifying that the borrower holds title to the collateralized intellectual property, verifying the borrower's premises, etc. In essence, this is the same standard of diligence reasonable lenders assume in granting any loan. The borrower is responsible for everything else. The Application for coverage should be completed by the principal-in-interest (the borrower, his investors and/or holders of bare legal title) since they have first-hand knowledge of the intellectual property collateral and the business operations. The Application should then be verified by the Named Insured (the Lender), just as the Lender would do before making any loan.

Correspondingly, the asset backed intellectual property insurance product may be used in conjunction with copyrights and registered trademarks. However, the use of copyrights and trademarks will be more transactional than the use of patents. Also the asset backed insurance can be used on a transaction basis to ensure the value of a portfolio of intellectual property or simply to guarantee a royalty stream from licensing the intellectual property.

Throughout this specification, the term intellectual property or (“intellectual property”) is used, this refers to a single item of intellectual property, to any group or portfolio of intellectual property, whether related or not, and whether the form is patent, copyright, trademark, trade dress, trade secret, domain and internet-related assets, network of associates and/or clients, associated know-how and the like, or pending as a patent application, unregistered or common law mark, or pending or future business favorable deals, for example. The only two requirements to intellectual property as the term is used in this specification is that it have positive value, as an asset, and that the value in the asset is primarily intangible, frequently stemming from the right or pending right to exclusivity.

This asset backed intellectual property insurance also address a long felt need of intellectual property owners, investors and financers for protection against the risk of a number of named perils. The asset backed intellectual property insurance policy can be used to provide a measure of stability to the now developing secondary market for patents through patent auctions. This policy offers financial institutions a buffer between the foreclosure on a patent asset pledged as collateral and the sale of that asset in the auction market.

As indicated, the asset backed intellectual property insurance policy insurance coverage is designed to reimburse the Named Insured or a lender for loss of value because of an adverse intellectual property happening. The customer base is intellectual property holders or third party beneficiaries such as investors or lenders similar to the Abatement and Defense product or, in certain cases, those entities who wish to avoid small company commercial risks by investing directly in the intellectual property.

The invention also is a process or method for establishing the value of an intellectual property asset, which value can be utilized in and of itself for a variety of financial, legal, transactional, and insurance purposes. The steps of indentifying intellectual property to be valued, and indentifying parties interested in knowing the value of the intellectual property can be accomplished by any of several specific methods, or a combination of methods. The preferred embodiment of the invention is that the entity determining the value offers a valuation service to an individual entity or publicly solicits interested individuals in any of a multitude of fo'ra and media. However, parties interested in an estimate of value of particular intellectual property could seek out an entity which has the expertise to establish the value, and this likewise would be within the scope of this invention. Either way, the interested entity is identified to the entity working to establish a value. Typically, the owner of the intellectual property will identify the items of intellectual property to be valued, but it is equally within the scope of this invention that the entity doing the valuation work would perform a search and identify items of intellectual property which might be ideal candidates for valuation, commercial transactions, and/or further services. This identification process could be either subsequent to identifying the owner, or the owner could be identified subsequent to an intellectual property search without respect to ownership in intellectual property. Whatever the circumstances under which a desire for a valuation of intellectual property assets arises, and however the interested parties and intellectual property are identified to the entity determining the value, all are within the scope of this invention, which can be expressed summarily as:
a) underwriting said one or more intangible assets by identifying and weighing commercial and legal risk of partial or complete loss of the intangible asset, which underwriting results in output in the form of an insurance quotation or report specifying a value or monetary limit of funds which are or could be made available and which amount could be reimbursed in the event of loss of the intangible asset through the vehicle of insurance, government guarantee, private entity guarantee or a combination of any or all of these to ensure against loss due to a commercial or legal risk of loss, cancellation, obsolescence, prohibition or the like of the intangible asset;
b) assigning a monetary value to the intangible asset based upon said output;
c) selling or leveraging said intangible asset, based upon the assigned monetary value of the intangible asset; and
d) engaging in financing or commercial activity enabled by the leverage or sale of said intangible asset.

Evaluating valuing the intellectual property involves several aspects. One of these aspects, determining the risk associated with licensing or enforcing intellectual property is described in U.S. Pat. No. 7,536,331, which has been incorporated by reference. The step of underwriting intangible assets also involves identifying and evaluating commercial and legal risk of partial or complete loss of the intangible asset. U.S. Pat. No. 7,536,331 identifies one hundred risk factors that may be used in calculating the degree of commercial and legal strength related to an item of intellectual property. The factors involving the legal risk provide insight into the likelihood of the strength of the intellectual property in the event that a competitor evaluates the strength of the intellectual property from a defensive position. Legal risk factors involve the relative strengths and weaknesses of the intellectual property in the event of a lawsuit, or from a defensive perspective of a competitor. The factual information reflected in the legal risk factors provides a basis for predicting a legal conclusion, which helps an evaluator predict whether the intellectual property will be valid and enforceable in the event of a lawsuit with a broad interpretation of the claims.

The commercial risk can be gleaned by reference to the number of infringements identified, and the identities of the infringers which thus provide a basis to predict future likelihood of infringement, in frequency and severity (amount at risk in controversy), and also to predict characteristics of the most likely future infringers with regard to size, sales, and product lines, for example. If one or more infringers is discovered for example, this will reduce the willingness of potential licensees to pay for rights to the infringed intellectual property. Either the infringement must be curtailed, or the valuation of the exclusive rights embodied in the intellectual property is correspondingly lower than it would otherwise be, all other factors being equal.

In the preferred embodiment, in addition to the risks associated with licensing or enforcement being considered in determining the value of intellectual property, the commercial and legal strengths and weaknesses of the intellectual property are evaluated. Even more preferably, if a commercial transaction such as insurance or financing activities will rely upon the valuation, the commercial and legal strengths and weaknesses of the intellectual property owner are also considered.

Valuations of the same intellectual property may vary, depending upon the purpose or context of the valuation, and the valuation method used. The number reflecting the value of an intellectual property can be given within the context of a net orderly liquidation value, the forced liquidation value, the monetary value to one similarly situated as the owner, the monetary value to another who is contextually positioned differently than the owner in the market, or in capital structure, or the likely sale price at auction, for instance. The valuation method differs depending upon the context of the valuation of the intellectual property. For the purposes of this invention, the particular valuation method is selected according to the circumstances. This invention pertains to the process as a whole and the formalization and reliance upon a specified value, in particular, is only one part. Thus, all of the above and any other methods of valuation fall within the scope of the valuation component of this invention.

Once the value of the intellectual property has been determined within a specific purpose or context, this information about the value can be used in the context of selling, licensing, or leveraging the intellectual property. For purposes of selling (assigning) and licensing, the value is used to calculate and negotiate the price and terms of a proposed sale or license arrangement. The value of the intellectual property which is sold or licensed should be formalized by a guarantee or insurance policy, in order to enable financing entities to rely upon that value. Types of financing activities that become available upon the guarantee of the value of an intellectual property include, but are not limited to, general commercial, non-profit, eleemosynary, venture capital, or commercial banking transactions. For example, intellectual property can serve as collateral for an asset-based loan, or can be the basis for a term loan. As another example, the intellectual property may be licensed, and the royalty payments (as valued and relied upon) can be the basis for a revolving loan. A lending institution may make a capital expenditure loan based upon the guaranteed value of the intellectual asset, to finance the owner's acquisition of similar or related pending or issued intellectual property. An individual, insurance company, business entity, or financial institution could guarantee the determined contextual value of an intellectual property.

Referring to FIGS. 3 and 4, the insurance and underwriting and program management entity of FIG. 1, evaluates all of the information including the application questionnaire, application research input and valuation analysis input, and performs due diligence to verify the accuracy or validity of the information. After analysis of this input, output in the form of an offer of terms including premium, policy language, and endorsements, for example, are prepared and provided to the intellectual property owner and lender. These insurance functions performed by the underwriting and program management entity can be performed either entirely in-house, by an insurance company (not shown), or with agents, brokers, or managing general agents working in association with the insurance company sharing and exchanging information about policies, agreements, premiums and fees. The insurance company, through brokers, agents, MGA, or directly, collects the required application and agreements through a point of contact and issues an insurance policy guaranteeing the value of the intellectual property, or some portion of that value, to the owner of the intellectual property in exchange for premium. Preferably, the insurance company also issues a litigation expense insurance policy for the defense and/or enforcement of the intellectual property. With the value guaranteed by insurance, the lender may take a security interest in the intellectual property and lend funds against the intellectual property, just as it would for a loan on tangible collateral. The intellectual property in fact is worth the insured value, subject only to the insuring entity's solvency, which is typically regulated and sometimes guaranteed by state or federal governments.

As noted in FIG. 1, lending institutions and intellectual property owners may use a third party as an intermediary. In such an arrangement, a special purpose vehicle entity (“SPV”) may serve as a third party. In such a case, the intellectual property owner may assign the intellectual property to a third party or SPV. As a result, the insurance policy guaranteeing the value of the intellectual property, and perhaps an insurance policy providing for the enforcement or the defense of the intellectual property, is extended to the third party or SPV, though much of the information provided and exchanged will also include the intellectual property owner. The lender loans funds to the intellectual property owner, and it remains the intellectual property owner's responsibility to repay that loan. However, the loan is issued to the intellectual property owner based upon the guarantee that in the event of the owner's default, the SPV will pay the unpaid loan balance.

The entities participating in the guarantee of value can include a central government or public interest entity. For example, in one such embodiment the insurance company may work to offer intellectual property value guarantees through a public-interest insurance provider made up in part by investment from, for example, labor unions, regional foundations, individuals (not shown) or other investing entities, including federal, state, or municipal government or a department thereof. In such a case, optionally the federal government can effectively re-insure the insurance or share the risk with the insurance company by capping losses to specified policy limits. The public interest insurance provider collects the agreements and application from the small business seeking insurance, in exchange for the policies from the insurance company (or companies) possibly in association with a federal program. Again, optionally, a special purpose vehicle may be used by the small business and lender, to hold the intellectual property collateral and be a beneficiary of the insurance policies, and to guarantee the balance owed the lender by the small business as a result of a loan. Optionally, an investment company or group of companies preferably with some experience or expertise in third party financial transactions may create special purpose vehicles specifically for this type of transaction.

Having thus described the invention what is claimed is:

1. A method of facilitating the use of intellectual property as a financial tool in commercial, non-profit, or eleemosynary activities in the context of both venture capital and commercial banking transactions comprising:
a) identifying one or more items of intellectual property;
b) identifying the owners of the intellectual property and any other principal in interest having rights directly or indirectly in said intellectual property, which owners, or actual or potential principal in interest have an interest in entering into commercial transactions involving said intellectual property;
a) valuing the intellectual property, identifying its strengths and weaknesses both commercially and legally; and
b) underwriting the intellectual property for purposes of issuing one or more policies of insurance covering one or more of the identified commercial or legal strengths or weaknesses.

2. The method of claim 1 wherein the underwriting of said intangible property is accomplished by identifying and weighing commercial and legal risk of partial or complete loss of the intangible asset.

3. The method of claim 2 wherein said underwriting results in output in the form of an insurance quotation or report naming a specific monetary limit of funds which define the amount for which to insure the commercial or legal risk of loss of the intangible asset.

4. The method of claim 1 wherein a lending institution lends money to said owner or principal in interest in exchange for a security interest in collateral, the collateral being said intellectual property.

5. The method of claim 4 wherein said lending institution is aware of said one or more insurance policies, and the existence of said one or more policies of insurance is a factor in the decision to lend, or in the terms of the loan.

1. The method of claim 5 wherein said lending institution takes a security interest in said collateral, and said one or more insurance policies is issued to said lending institution, insuring said collateral against loss up to a specified monetary limit.

2. The method of claim 6 wherein said specified monetary limit approximates the potential sale proceeds from said collateral in the event of an orderly liquidation.

3. A process of engaging in financial activity involving leverage or sale of an intangible asset, comprising the steps of:
a) gathering input data from one or more information sources regarding an intangible asset;
b) evaluating said input by identifying and weighing commercial and legal risk of partial or complete loss of said intangible asset;
c) creating output in the form of an insurance quotation or report regarding said intangible asset naming a specific monetary limit of funds which are available for purchase to insure the commercial or legal risk of loss of the intangible asset;
d) assigning a monetary value to the intangible asset based at least in part upon said output;
e) selling or leveraging said intangible asset, based upon the assigned monetary value of the intangible asset; and
f) engaging in financing activity enabled by the leverage or sale of said intangible asset.

9. The process of claim 8 comprising the additional step of: engaging in financing activity enabled by the leverage or sale of said intangible asset.

10. The process of claim 9 wherein said financing activity enabled by the leverage or sale of said intangible asset is a loan, from a lender and said loan requires said intangible asset as collateral.

11. The process of claim 10 wherein the lender takes a security interest in said collateral, and said insurance quotation or report is issued to said lender, insuring said collateral against loss up to a specified monetary limit of funds.

12. A method of assigning a specific monetary value to intangible assets, comprising:
a) identifying one or more intangible assets;
b) identifying the owners of said intangible asset and any other actual or potential principals in interest having or intending to have rights directly or indirectly in said intangible assets, which owners or actual or potential principals in interest enter into one or more commercial transactions involving said intangible assets, or for adopting or justifying a specific monetary value of said intangible assets for accounting purposes;

13. The method of claim 12 wherein a monetary value is assigned to the intangible asset based upon said output.

14. A specific monetary value assigned to an intangible asset, comprising:
a) underwriting said intangible asset by identifying and weighing commercial and legal risk of partial or complete loss of the intangible asset, which underwriting results in output in the form of an insurance quotation or report naming a specific monetary limit of funds which are available for purchase to insure the commercial or legal risk of loss of the intangible asset; and
b) assigning a monetary value to the intangible asset based upon said output.

15. An insurance product comprising: an insurance policy issued to a holder in exchange for premium, which compensates said holder in the event of loss of one or more items of intangible collateral, where said holder has loaned money to an entity and taken a right in one or more intangibles as collateral for the loan.
